(19) United States
(12) Patent Application Publication
(10) Pub. No.: US 2012/0298716 A1
(43) Pub. Date: Nov. 29, 2012

(54) Fastener collation having a collation of frangible fastener alignment caps

(76) Inventor: Ricardo Segura, Lake In The Hills, IL (US)

(21) Appl. No.: 13/113,117

(22) Filed: May 23, 2011

(51) Int. Cl. B25C 7/00; B65D 85/24; B25C 1/00

(52) U.S. Cl. 227/135; 206/343; 206/345; 206/338

(57) ABSTRACT

A fastener collation includes a collation of alignment caps fitted over the pointed ends of respective fasteners for maintaining the fasteners in a parallel-spaced configuration for positioning the nosepiece of a pneumatically powered fastener-driving tool for driving a fastener, such as a nail, through an aperture in a workpiece, such as a metal channel, into an underlying workpiece, such as a wood beam. The alignment caps each include a convex tip which enables tactile placement of the nosepiece of the tool when the tip is dragged on the surface of the workpiece with the purpose of positioning the tip into the aperture.

### CROSS-REFERENCE TO RELATED APPLICATION

None.

### BACKGROUND OF THE DISCLOSURE

I. Field of the Disclosure

The present disclosure relates generally to a collation of fasteners suitable for feeding into the driving end of a powered fastener-driving tool which includes a collation of alignment caps for aligning the tips of the fasteners such that fasteners can be precisely driven by the tool through apertures in a workpiece being fastened to another workpiece. In particular, the alignment cap collation comprises a series of alignment caps, arranged in a stair-step configuration and joined together by frangible connecting bridges. The caps having bores in one end into which the pointed tips of a like number of parallel-spaced fasteners such as nails are inserted, and a convex pointed surface on the other end adapted to seat in the workpiece apertures. After the alignment cap in which the next fastener to be driven is inserted has been aligned over the workpiece aperture, the fastener driving tool is actuated to drive the fastener through the aperture. At the same time, the alignment cap breaks away from the remaining alignment caps of the cap collation to allow the next to be driven fastener to move into position in the tool.

II. Description of the Prior Art

Commonly, a pneumatically-powered or combustion-powered fastener driving tool is used by a tradesperson for driving a fastener, such as a nail, through an aperture in a first workpiece, such as a metal channel, into a second workpiece, such as a wooden beam, which underlies the first workpiece. Typically, fastener driving tools incorporate a nosepiece, which functions to guide the driven fastener into the aperture of the underlying workpiece. Because the tool itself tends to obscure the aperture from the tradesperson, it can be difficult to align the nosepiece so that the fastener is precisely driven through the aperture. This alignment issue is particularly problematic during the installation of clips, straps and other metal workpieces using nails and a power driven tool because such metal workpieces require precise nail placement with respect to the apertures in the workpieces.

Using the nail tip itself as the locating device has the potential advantage of enabling the tradesperson to visually confirm that the nail tip is aligned with the aperture. However, as metal connectors are typically similar in color to nails, it can be difficult in poorly lit work environments to visually confirm alignment, resulting in improper alignment of the nail and/or compromise of the nail collation. Moreover, once the tip of the nail has been seated in the aperture, the tradesperson may move the nail circularly and fore and aft prior to actuation of the nail driving tool. This action can result in the nail falling out of the tool, mis-aligning with the aperture, or jamming in the tool.

The use of an alignment probe in a powered fastener-driving tool is shown in U.S. Pat. No. 5,052,607 and in U.S. Pat. No. 5,238,167, which are incorporated herein by reference.

These additional probe mechanisms add to the complexity and cost of manufacture of the fastener-driving tools. Furthermore, the greater complexity increases the possibility of part failure and malfunction of the fastener-driving tool.

Accordingly, it is a general object of the present disclosure to provide an improved fastener collation for feeding fasteners to a powered fastener driving tool.

It is a more specific object of the present disclosure to provide a fastener collation which includes a collation of alignment cps which position the fasteners in the collation and align the fastener being driven relative to an underlying workpiece aperture.

It is another specific object of this disclosure to provide a collation of alignment caps for a fastener collation which retains the fasteners in the collation and enables the fasteners of the collation to be precisely aligned with and driven through an underlying aperture in a workpiece.

It is another specific object of this disclosure to provide an alignment cap which fits over the pointed end of the fastener to align the fastener with an underlying aperture.

These and other objects, features and advantages of the disclosure will be clearly understood through a consideration of the following detailed description.

### SUMMARY OF THE DISCLOSURE

According to one embodiment of the present disclosure, there is provided a fastener collation for a powered fastener-driving tool. The fastener collation includes a collation of alignment caps arranged in a stair-step configuration and including a bore on one end dimensioned to receive a pointed shank end of a fastener, and a convex pointed surface on the other end dimensioned to seat in an underlying aperture. Adjacent alignment caps preferably have a frangible interconnection adapted to hold the caps in the stair-step configuration while allowing the caps to separate when penetrated by the shank of a driven nail.

There is also provided an alignment cap collation for use in a fastener collation for use with a powered fastener-driving tool. The alignment cap collation includes a plurality of individual alignment caps arranged in a stair-step configuration which each include a bore on one end dimensioned to receive the pointed shank end of an associated fastener and a convex pointed end for indexing the cap in an aperture on the other end, and which are interconnected by a series of frangible bridge sections.

There is further provided a system for aligning the tip of a fastener positioned on the driving end of a powered fastener-driving tool to enable the fastener to be precisely driven by the tool through an aperture in a workpiece to be fastened to another workpiece. The tool receives a collation of fasteners wherein the fasteners are arranged in a stair-case fashion and are held in parallel-spaced alignment by a collation of alignment caps. The cap collation includes a plurality of individual caps each provided with a bore on one end dimensioned to receive the pointed shank of an associated fastener and a convex point on the other end for engaging an underlying aperture, and which are interconnected by a frangible connection.

There is further provided an alignment cap having a bore on one end dimensioned to receive the pointed end of a fastener, such as a nail, and a convex point on the other end for aligning the fastener with an underlying aperture.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is a perspective top plan view of a pneumatically powered fastener-driving tool having a conventional art alignment probe for aligning the fastener prior to driving the fastener.

FIG. 2 is a partial cross-sectional side view of the tool of FIG. 1 showing the alignment probe.

FIG. 3 is a partial cross-sectional side view of the tool of FIG. 1 following actuation of the tool and subsequent driving of a fastener into a workpiece.

FIG. 4 is a top plan view of a conventional art fastener collation for use with a power driven fastener-driving tool.

FIG. 5 is a top plan view of a fastener collation incorporating an alignment cap collation in accordance with one aspect of the present disclosure.

FIG. 6 is a partial cross-sectional side view of a pneumatically powered fastener-driving tool for use with the fastener collation of FIG. 5.

FIG. 7 is an exploded cross-sectional view of the fastener workpiece engaging area of FIG. 6.

FIG. 8 is a cross-sectional side view of the fastener collation of FIG. 5 together with a fastener workpiece engaging area.

FIG. 9 is an enlarged cross-sectional view of one alignment cap of the alignment cap collation shown in FIG. 5 positioned within the workpiece area of FIG. 8.

### DESCRIPTION OF THE PREFERRED EMBODIMENTS

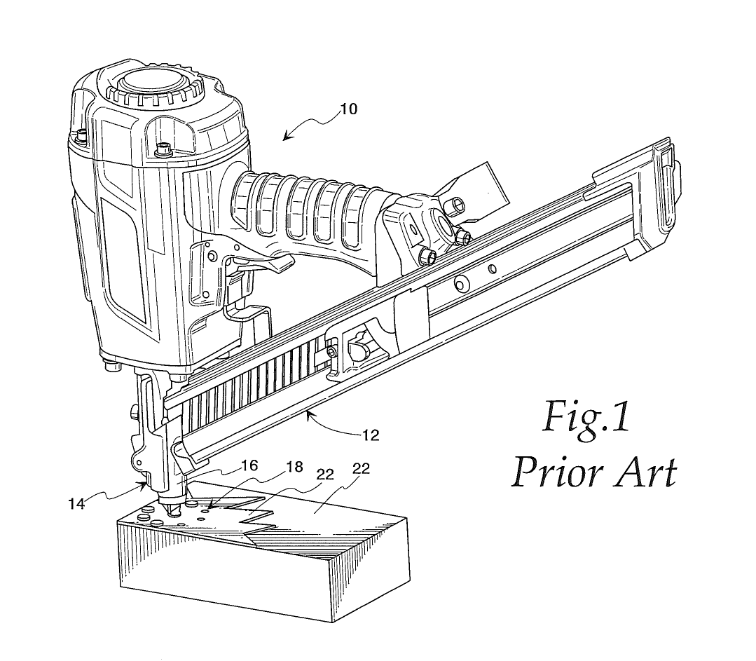

One or more embodiments of the subject disclosure will now be described with the aid of the drawings. As shown in FIG. 1, a pneumatically powered fastener-driving tool 10 for driving fasteners, such as nails, as fed from a magazine 12 of the tool, comprises a conventional art mechanism 14 for positioning a nosepiece 16 of the tool 10 so that a nail can be precisely driven by the tool 10, through a circular opening 18 of a workpiece 20, into a substrate 22 adjacent to the workpiece 20. As shown, the workpiece 20 is a metal bracket, and the substrate 22 is a wooden beam.

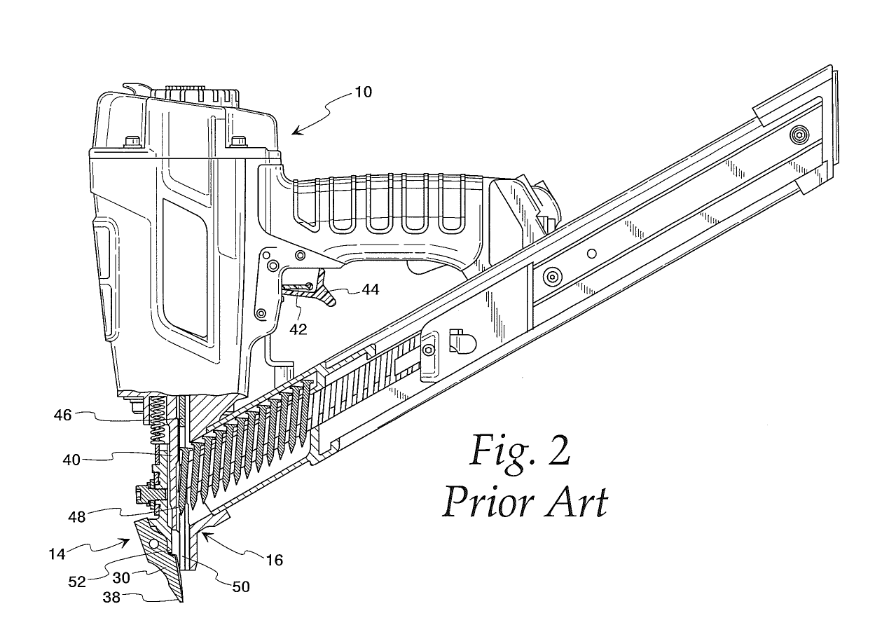

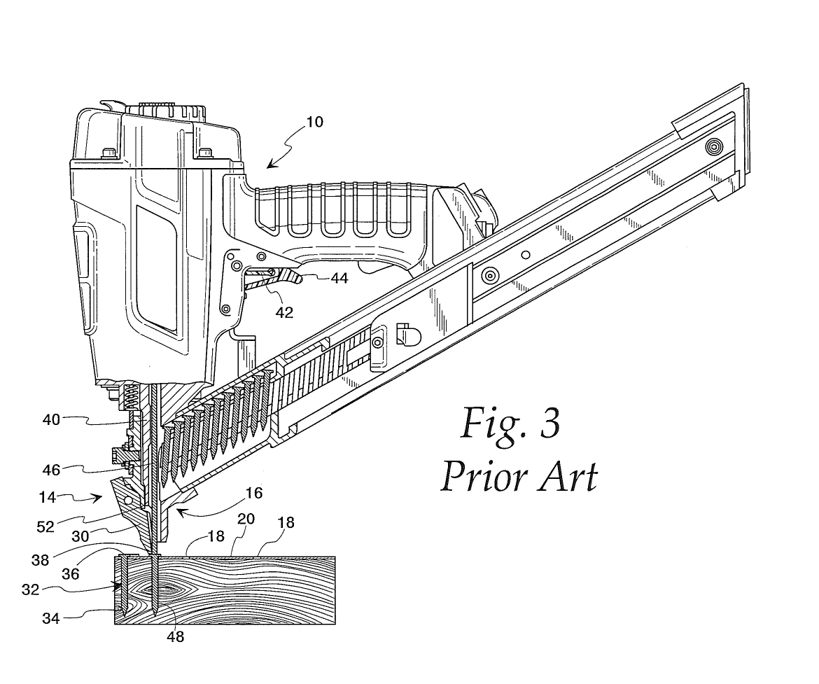

The conventional art mechanism 14 is more specifically shown in FIGS. 2 and 3. In particular, the mechanism 14 comprises an alignment probe 30, which is connected to the nosepiece 16 and which is adapted to extend into an aperture 18 of workpiece 20, for aligning the nosepiece 16 relative to the aperture 18 so that the fastener (exemplified by wire nails 32 having pointed shanks 34 and enlarged heads 36) can be precisely driven through the aperture 18. As shown, alignment probe 30 has a tapered end 38, which extends into the aperture 18.

The tool 10 is similar to known pneumatically powered fastener-driving tools. Thus, the tool 10 has an actuator 40 mounted operatively to the nosepiece 16 and linked operatively to a lever 42, which is mounted pivotally to a trigger 44. The alignment probe 30 is connected to the actuator 40 so as to be conjointly movable with the actuator 40 so as to be pivotally movable, and is adapted to be pressed firmly against the workpiece 20 to move the actuator upwardly so as to lift the lever 42. Upon actuation of the trigger 44, a nail 32 is driven by the ram 46 and its shank 48 is driven along the groove 50, defined by the alignment probe 30 facing laterally, until its head 36 engages the rounded surface 52 of the alignment probe 30, whereupon the nail 32 moves the probe 30 laterally and from the opening 18 as the tool 10 recoils.

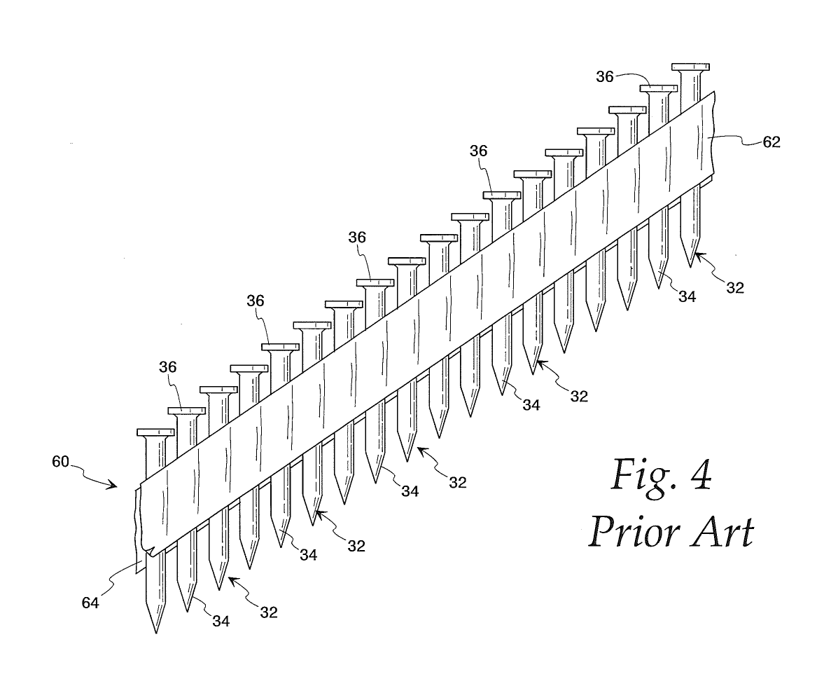

The conventional art fasteners typically used by such tools 10 are nails such as shown in FIG. 4. In particular, FIG. 4 shows a collation 60 of nails 32 in parallel-spaced alignment wherein each nail includes a pointed shank 34 and an enlarged head 36. The collation 60 is maintained with front 62 and back 64 paper adhesive tape strips. These collation strips are loaded into the tool 10 and fed from the magazine 12.

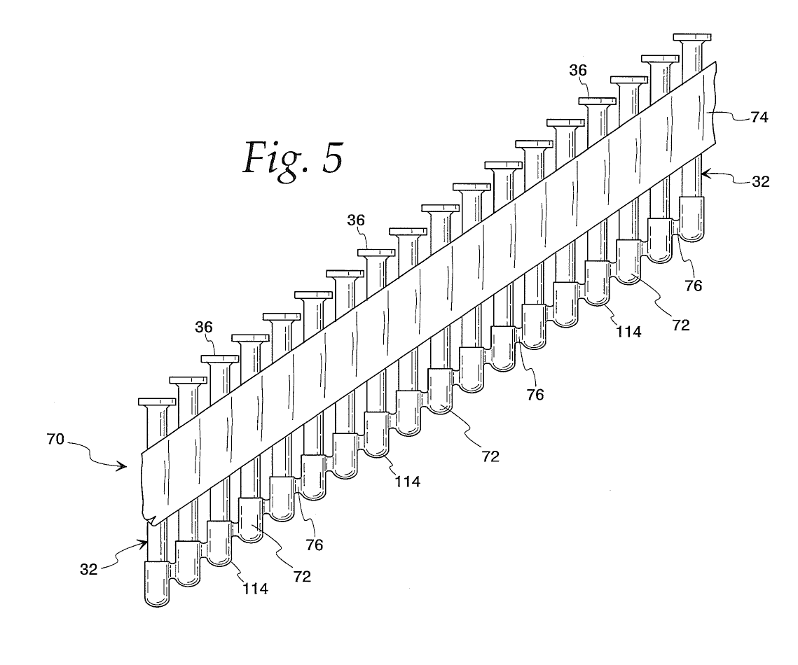

Referring now to FIG. 5, a fastener collation 70 constructed in accordance with one aspect of the disclosure includes a collation of nails arranged in an adjacent stairstep configuration, wherein each nail 32 includes an enlarged head 36 on one end and a pointed shank 34 on the other end. For purposes of this description, the collation is described in a staggered configuration, however, it will be understood that the collation can be aligned at various angles, and preferably between zero and 40 degrees. In any event, an alignment cap 72 associated with each nail includes a bore on one end dimensioned to sheath the pointed shank of the nail and includes a convex pointed tip portion 114 on its other end. The collation 70 is maintained with a single paper adhesive tape strip 74 as well as the alignment caps, which are joined by bridge portions to form a collation of alignment caps. It will be appreciated that both front and rear paper adhesive strips can be used. In any event, the plurality of nails, the collation of alignment caps, and the adhesive tape comprise the fastener collation to be used with the tool.

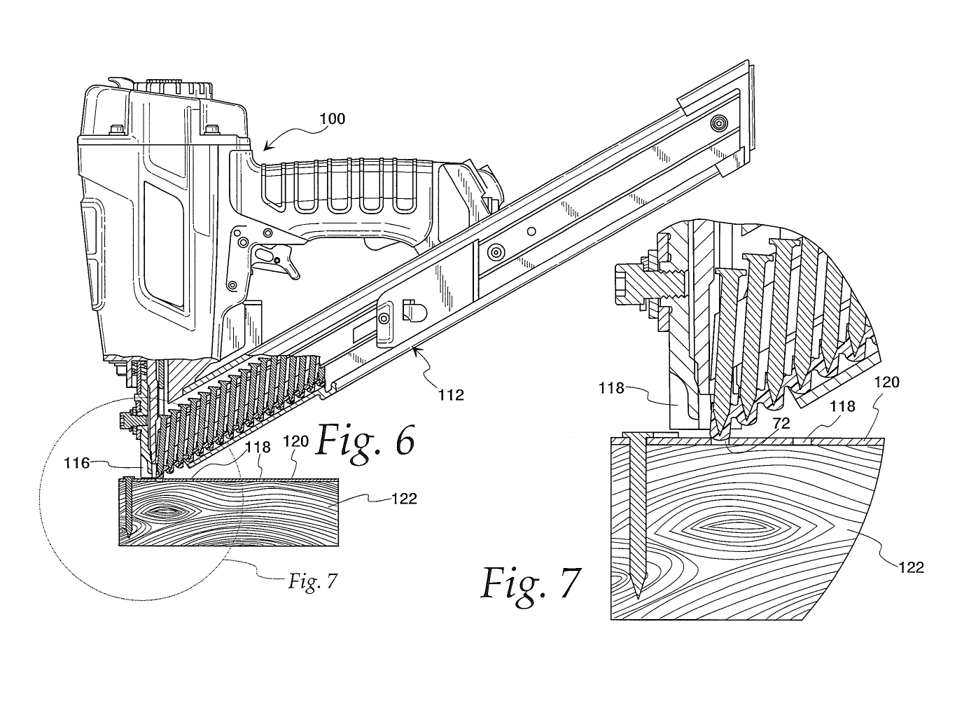

As shown in FIG. 6, a pneumatically powered fastener-driving tool 100 for driving fasteners, as fed from a magazine 112 of the tool uses the convex tip 114 (see FIG. 5) of the cap 72 for positioning a nosepiece 116 of the tool 100 so that a nail can be precisely driven by the tool 100, through an aperture 118 of a workpiece 120 into a substrate 122 adjacent to the workpiece 120. As shown, workpiece 120 may be a metal bracket, and the substrate 122 may be a wooden beam.

Turning now to FIG. 7, the convex tip 114 permits the tactile placement of the nosepiece 116 when the tip is intentionally dragged on the surface of the workpiece 120 with the purpose of locating the tip 114 into the aperture 118. More specifically, such intentional dragging will be interrupted when the convex tip comes in contact with the aperture in the metal connector or strap. As will be described more fully below, alignment cap 72 and frangible cap connector portions 76 are made from frangible materials such as, for example, polypropylene, which permits, upon actuation, the pointed nail shank to readily penetrate the cap tip 114 and further permits the alignment cap 72 of the driven nail to separate from its adjacent cap.

As shown, a collation of alignment caps 72 connected via frangible bridge sections 76 form a strip-like assembly to complement the strip of nails. The collation of alignment caps 72 can be made from known techniques, including, for example, injection molding. The collation can be molded independently from the nails and then presented and assembled to the nails. Alternatively, the caps can be formed simultaneously over the shanks of the nails in a strip with the upper collation media (paper or plastic collation). Ideally, a single plastic material could be used to form the upper collation media and the cap at the same time.

The collation of alignment caps 72 is designed to be sufficiently strong to maintain the integrity of the collation and at the same time sufficiently frangible so as to permit penetration and separation of the individual caps. Additionally, the collation is preferably a molded colored polypropylene, such as, for example a so-called Paslode® Orange, which aids in visual contrast when placing the tip in the aperturte. When the convex tip is registered with the aperture, the cap collation (due to the tip connectors 76) permits circular, fore and aft, left to right adjustment prior to nail penetration.

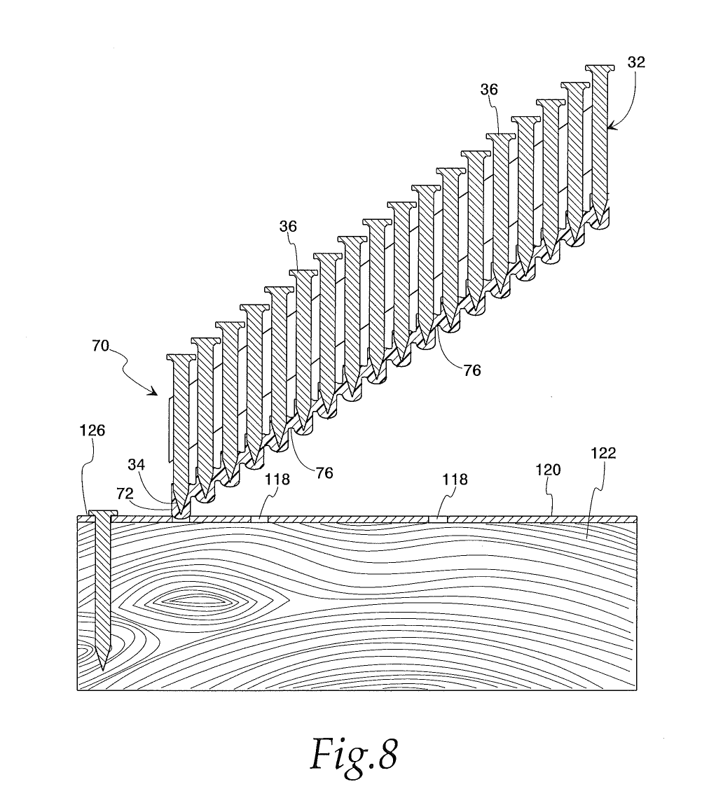

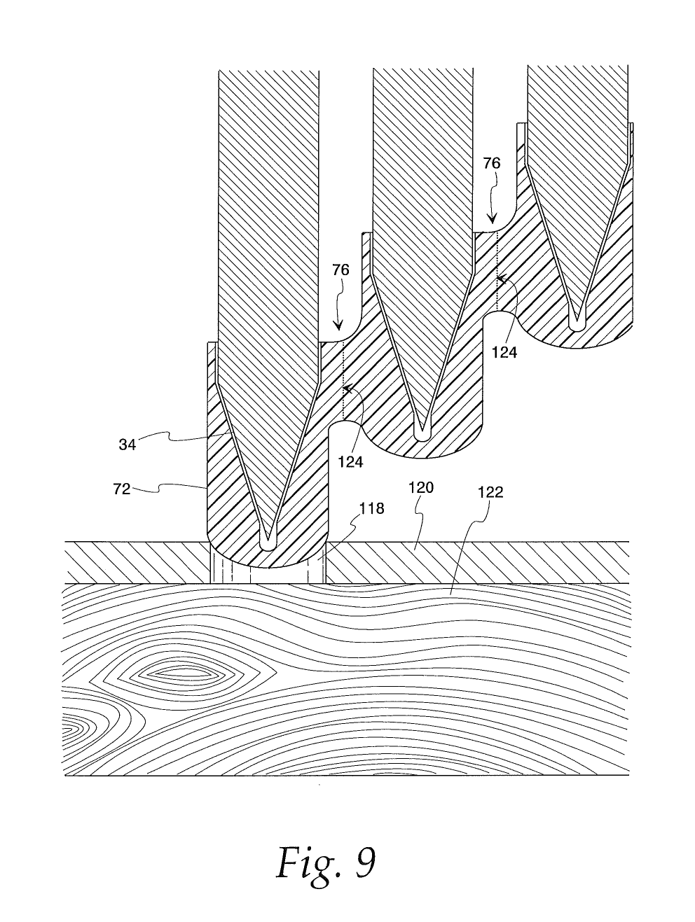

FIGS. 8 and 9 illustrate the interaction of an alignment cap and the fastener workpiece engaging area. This interaction is shown without the tool 100 so as to better focus on the specifics of the cap. In particular, a cross section of the fastener collation 70 is shown prior to the tool driving the fastener through the aperture in the workpiece. The fastener (nail) includes an enlarged head 36, a pointed shank 34 and an alignment cap 72. The cap must be larger than the aperture 118 in the metal hardware. When the nail 32 is driven, the alignment locator cap 72 for that particular nail 32 breaks away along line 124 of adjacent alignment bridge section 76 thereby enabling the nail to enter the aperture 118 of the workpiece 120 and into substrate 122.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the disclosure if its broader aspects, and, therefore, the aim in the appended claims is to cover all such changes and modifications as fall within the true spirit and scope of the present disclosure.

What is claimed is:

1. A fastener collation for use in conjunction with a powered fastener-driving tool, said collation comprising:
a plurality of individual fasteners held in a parallel-spaced configuration by a collation of alignment caps;
each of said alignment caps in said alignment cap collation including a bore on one end dimensioned to receive the pointed shank end of an associated fastener and a convex point on the other end for seating in an underlying aperture, and interconnected by a series of intervening frangible bridge sections.

2. A fastener collation as defined in claim 1 wherein said plurality of individual fasteners are further held in parallel-spaced alignment by at least one adhesive strip.

3. A fastener collation as defined in claim 1 wherein said bridge sections are adapted to fracture upon penetration of an adjacent alignment cap by the pointed shank of a driven fastener.

4. A fastener collation as defined in claim 1 wherein said alignment cap collation is injection molded from a polypropylene material.

5. A fastener collation as defined in claim 1 wherein said alignment cap collation is colored to provide visual contrast to a workpiece.

6. A collation of alignment caps in a fastener alignment collation for use in conjunction with a powered fastener-driving tool, said collation comprising:
a plurality of individual alignment caps arranged in an adjacent configuration and interconnected by a frangible interconnection;
each of said alignment caps including a bore at one end dimensioned to receive a pointed shank end of a fastener to maintain the fasteners in a said configuration; and
said caps each including a convex tip at its other end adapted to engage an aperture in an underlying workpiece.

7. An alignment cap collation as defined in claim 6 wherein said collation is injection molded from a polypropylene material.

8. An alignment cap collation as defined in claim 6 wherein said assembly is colored to provide visual contrast to a workpiece.

9. A system for aligning the tip of a fastener positioned on the driving end of a powered fastener-driving tool to enable a fastener to be precisely driven by the tool through an aperture in a first workpiece to be fastened to a second workpiece, said system comprising:
a powered fastener-driving tool having a cartridge for receiving a collation of fasteners; and
said collation of fasteners having a plurality of individual fasteners arranged in an adjacent configuration and held in parallel-spaced alignment by an alignment cap collation, said cap collation comprising a plurality of individual alignment caps dimensioned to receive the pointed shank of an associated fastener and including an intervening frangible interconnection between adjacent caps.

10. The system as defined in claim 9 wherein said plurality of individual fasteners are further held in parallel-spaced alignment by at least one adhesive strip.

11. The system as defined in claim 9 wherein said bridge sections are adapted to separate from adjacent alignment caps upon actuation of said tool and penetration of the shank of a driven fastener.

12. The system as defined in claim 9 wherein said alignment cap collation is injection molded from a polypropylene material.

13. The system as defined in claim 9 wherein said alignment cap collation is colored to provide visual contrast to a workpiece.

14. An alignment cap for aligning a fastener having a head end and a pointed shank end with an underlying workpiece comprising:
a bore on one end for receiving the pointed shank end of the fastener; and
a convex tip on the other end for indexing the fastener in an aperture in an underlying workpiece.

15. An alignment cap as defined in claim 14 wherein said cap is injection molded from a polypropylene material.

16. An alignment cap as defined in claim 14 wherein said cap is colored to provide visual contrast to a workpiece.
